(19) United States
(12) Patent Application Publication
(10) Pub. No.: US 2007/0168648 A1
(43) Pub. Date: Jul. 19, 2007

(54) Modular computing system

(75) Inventors: Eitan Mardiks, Ra'Anana (IL); Mishael Agami, Netanya (IL); Itzhak Pomerantz, Kefar Saba (IL)

Correspondence Address: DR. MARK FRIEDMAN LTD.;C/o Bill Polkinghorn, 9003 Florin Way, Upper Marlboro, MD, 20772, US

(73) Assignee: MSYSTEMS LTD.

(21) Appl. No.: 11/540,563

(22) Filed: Oct. 2, 2006

Related U.S. Application Data
(60) Provisional application No. 60/722,914, filed on Oct. 3, 2005.

(51) Int. Cl. G06F 15/00; G06F 15/76

(52) U.S. Cl. 712/36

(57) ABSTRACT

The present invention discloses systems and methods for a computing portal system including: a computing engine for performing computing operations; at least one memory component for storing program code of an operating system; a computing-engine connector for providing operational connectivity to the engine, wherein the connector is a contact pad; a solid package for housing the engine, at least one memory component, and the connector; at least two peripheral assemblies, each assembly for providing power and resources when operationally connected to the connector; and program code, residing on at least one memory component, for enabling functional operation of the engine as a main processing unit of each computing portal, wherein each computing portal includes the computing engine and one assembly, upon operational connection of the engine to one assembly.

This patent application claims the benefit of U.S. Provisional Patent Application No. 60/722,914 filed Oct. 3, 2005.

### FIELD AND BACKGROUND OF THE INVENTION

The present invention relates to systems and methods for a distributed digital processing system where the main processing unit is a small computing engine (i.e. computing device) physically ported from one location to another, acting as the main processing system and the driver of the peripherals wherever the system performs. The present invention also includes a peripheral assembly, containing computer peripherals, that becomes a complete computing system when hosting a computing engine.

A computing device is an electronic system that contains a processing unit. There are many types of computing devices that differ in their architecture and use. There are personal-use computing devices, such as personal computers, portable and non-portable computers, personal digital assistants (PDA), gaming devices, phones (regular and mobile), and more. Some of the personal computing devices integrate more than one functionality into a single device (e.g. a cellular phone that has PDA functionality). Other non-personal computing devices include general-purpose industrial controllers, or dedicated control systems designed for various applications.

In computer design, there is an ongoing effort to minimize the size and cost of portable computing devices, making them easier to carry. However, there is an inherent conflict between the need to make the device as small as possible in the interest of portability, and the need to make the device's human interfaces (e.g. keyboard, mouse, and display) as large as necessary for the convenience of the user.

It would be desirable to have a computing device that eliminates expensive components, can be carried in the user's wallet, while also having the ability to connect to larger peripherals upon operation when needed. Limitations of prior art computing systems, such as security, synchronization, and upgrade costs, would also be reduced if such a computing system were available.

### SUMMARY OF THE INVENTION

It is the purpose of the present invention to provide a distributed digital processing system in which the main processing unit is a small computing engine physically ported from one location to another, acting as the main processing system and the driver of the peripherals wherever the system is operational. The present invention also includes a peripheral assembly, containing computer peripherals, that becomes a complete computing system when hosting a computing engine.

For the purpose of clarity, several terms which follow are specifically defined for use within the context of this application. The term “computing engine” is used in this application to refer to a portable computing device, as was described above, which is small, portable, and can carry a CPU, RAM, storage, and software required for computing. The term “peripheral assembly” is used in this application to refer to a stationary or mobile collection of at least one peripheral device, a power source, and communication interfaces that are required for interfacing between a computing engine and a user, and a computing engine and a network. The communication interfaces mentioned here are not to be confused with bus interfaces and connectors that are required for interfacing between a computing engine and a peripheral assembly which may reside on a computing engine. In addition, the peripheral devices may include a “mediator” computer for provide the computing engine with access to peripheral devices and power residing on the mediator computer and/or a network of the mediator computer. Such a mediator computer would serve to provide the resources (i.e. power and peripherals) to the computing engine without the mediator computer being involved in operations performed by the computing engine.

The term “computing portal” is used in this application to refer to the combination of a computing engine connected to a peripheral assembly. The term “computing portal system” is used in this application to refer to the combination of a computing engine and at least two peripheral assemblies.

Furthermore, the term “RAM” is used in this application to refer to a high-speed, random access memory used for storing temporary data. The term “storage” is used in this application to refer to a non-volatile memory typically used for storing applications, databases, and files. The term “contact pad” is used in this application to refer to a connector in which, for at least one of the connector's contacts, the electrical connection is made using a flat, conducting surface parallel to the surface of the card that the connector is mounted on, thereby enabling contact with a corresponding conductor of a matching connector. An example of such a connector is the smartcard 8-pin connector defined by the ISO 7816 standard. The term “small” is used in this application to refer to a device with a total volume of less than about 5 cubic centimeters. The term “solid package” is used in this application to refer to a package of solid components, where most of the package's volume is made of solid material without moving or removable parts, such as a plastic card with embedded electronic components.

A computing engine can be moved among multiple peripheral assemblies and perform operations (i.e. execute any of the computing engine's capable operations) on each peripheral assembly when attached, and can be optionally powered by each peripheral assembly as well. Likewise, a peripheral assembly can host, from time to time, different computing engines, allowing each computing engine to use power from the peripheral assembly and perform operations for the peripheral assembly.

The user typically carries the personal computing engine and plugs the computing engine into any available peripheral assembly for operation. A matching multi-pin connector on the computing engine and on the peripheral assembly enables the computing engine to be plugged into the peripheral assembly. Preferably, all the computing engines are compatible with all peripheral assemblies. As peripheral assemblies differ in their architecture (different printers, different displays, different keyboards, and so on), the storage of the computing engine contains a large variety of device drivers. The computing engine software is configured to identify the specific characteristics of the peripheral assembly, and activate the corresponding requisite drivers.

Since a typical computing engine has no moving parts, ventilation openings, or breakable components, the computing engine can be designed to be waterproof, and to withstand harsher environmental conditions than any other types of computer. This attribute makes the computing engine a very durable, reliable, and easily-transportable device. Furthermore, since the peripheral assembly does not need to have any of its own storage or computing power, the computing engine provides enhanced data security. The hosting peripheral assembly, which may be located in a non-secure area, is not likely to contaminate the computing engine with hostile software (e.g. viruses, malware, spyware, etc.). Optionally, the computing engine also includes a secured access control for preventing unauthorized access to the computing engine.

The separation between the CPU, RAM, storage, and software in one part of the system, and the peripherals in the other, enables the computing engine to be a small, sturdy, inexpensive device that is easy to transport; whereas, the peripheral assembly often is a large, mechanically-sensitive, expensive set of components that is likely to be stationary.

As mentioned above, the computing engine can move from one peripheral assembly to another, and perform the computing services of the computing engine on any peripheral assembly. It should be noted that the peripheral assembly can be a portable device, such as a mobile phone or a PDA, which typically has a display, an input device, a speaker, and a modem, enabling the user to operate the computing engine in mobile conditions when no stationary peripheral assembly is available. Clearly, the mobile functionality of such a peripheral assembly (i.e. mobile phone or PDA) is limited due to the reduced screen size of the display and the reduced input capability of the input device (i.e. relative to a standard keyboard).

Typical operating scenarios of the present invention include the following:

(1) A guest in a hotel can use the computing engine on a “public-portal” peripheral assembly located in the hotel business center or in a hotel room. A typical peripheral assembly in a hotel is comprised of a large, high-resolution display, full keyboard, and possibly other peripherals, such as a printer, a scanner, and a fax machine. This type of peripheral assembly is typically connected to the Internet, which enables the computing engine to access email services and browse the Internet, and connect to other network servers. A peripheral assembly with similar capabilities might also be located in an Internet Café.

(2) A diner in a coffee shop might use a hand-held “personal-portal” peripheral assembly. This peripheral assembly has the form factor of a PDA, and might include cellular, WiFi, WiMax, or other means of communication. This type of peripheral assembly has a reduced size, a limited keypad (smaller than a typical keyboard), and a compact screen, but still enables the user to perform a variety of tasks, such as writing documents, sending/receiving emails, and browsing the Internet for information. This type of peripheral assembly is typically owned by the same owner of the computing engine.

(3) A passenger on a vehicle, such as an airplane or a train, might have a seat equipped with a “seatback-portal” peripheral assembly. A typical peripheral assembly is an airplane or train seatback equipped with a computer display, folded keyboard, and means of communication that can be used by the person sitting behind this seatback. This type of peripheral assembly would provide a more enhanced working environment than the personal-portal peripheral assembly, but with less functionality than what might be available from a public-portal peripheral assembly.

Therefore, according to the present invention, there is provided for the first time a computing portal system including: (a) a computing engine for performing computing operations; (b) at least one memory component for storing program code of an operating system; (c) a computing-engine connector for providing operational connectivity to the computing engine, wherein the computing-engine connector is a contact pad; (d) a solid package for housing the computing engine, at least one memory component, and the computing-engine connector; (e) at least two peripheral assemblies, each peripheral assembly for providing electrical power and peripheral resources when operationally connected to the computing-engine connector; and (f) program code, residing on at least one memory component, for enabling functional operation of the computing engine as a main processing unit of each computing portal, wherein each computing portal includes the computing engine and one of at least two peripheral assemblies, upon operational connection of the computing engine to one peripheral assembly.

Preferably, one of the peripheral assemblies is a mobile phone.

Preferably, the each peripheral assembly includes at least one connector for interfacing with the computing engine.

Preferably, the package has a Smartcard ID1 form factor.

Preferably, the package has a Smartcard ID-000 form factor.

Preferably, the computing-engine connector is a sole computing-engine connector.

Preferably, at least one peripheral assembly is a fully-functional computing system.

Most preferably, the fully-functional computing system is configured to assist in performing computing operations in conjunction with the computing engine, thereby enabling the computing engine to function as a co-processor to the fully-functional computing system for computationally-intensive tasks.

Preferably, the computing engine includes a secured access control for preventing unauthorized access.

Preferably, the memory component is a non-volatile data-storage device.

Most preferably, at least one memory component is a ROM component.

Preferably, the contact pad is an ISO 7816 standard connector.

Preferably, the package is dimensioned to be smaller than about 5 cubic centimeters.

According to the present invention, there is provided for the first time a computing portal system for logically switched operation between devices, the system including: (a) a computing engine for performing computing operations; (b) at least one memory component for storing program code of an operating system; (c) a computing-engine connector for providing operational connectivity to the computing engine, wherein the computing-engine connector is a contact pad; (d) a solid package for housing the computing engine, at least one memory component, and the computing-engine connector; (e) at least two peripheral assemblies, each peripheral assembly for providing electrical power and peripheral resources when operationally connected to the computing-engine connector; (f) program code, residing on at least one memory component, for enabling functional operation of the computing engine as a main processing unit of each computing portal, wherein each computing portal includes the computing engine and one of at least two peripheral assemblies, upon operational connection of the computing engine to one peripheral assembly; and (g) a peripheral-assembly interface residing on a first peripheral assembly, wherein the computing engine is configured to be engaged within the first peripheral assembly via the computing-engine connector, and is configured to be logically switched from operating with the first peripheral assembly to operating with a second peripheral assembly, via connection of the peripheral-assembly interface to the second peripheral assembly, without the computing engine being disengaged from the first peripheral assembly.

Preferably, the first peripheral assembly is a mobile phone.

Preferably, the peripheral-assembly interface includes a wireless communication link.

Preferably, the peripheral-assembly interface includes a wired communication link.

According to the present invention, there is provided for the first time a computing engine consisting essentially of: (a) a solid package; (b) a processor for performing computing operations, the processor housed in the package; (c) at least one memory component for storing program code of an operating system, at least one memory component housed in the package; (d) a computing-engine connector, housed in the package, for providing electrical power and operational connectivity to the processor by connecting the connector to a peripheral assembly, wherein the computing-engine connector is a contact pad; and (e) program code, residing on at least one memory component, for enabling functional operation of the computing engine as a main processing unit of a computing portal, wherein the computing portal includes the computing engine and the peripheral assembly, upon operational connection of the computing engine to the peripheral assembly, thereby distinguishing the present invention from the prior art.

Preferably, the package has a Smartcard ID1 form factor.

Preferably, the package has a Smartcard ID-000 form factor.

Preferably, the peripheral assembly includes a mobile phone.

Preferably, the contact pad is an ISO 7816 standard connector.

Preferably, the memory component is a non-volatile data-storage device.

Most preferably, the memory component is a ROM component.

Preferably, the package occupies a volume of less than about 5 cubic centimeters.

According to the present invention, there is provided for the first time a computing engine for logically switched operation between devices, the computing engine consisting essentially of: (a) a solid package; (b) a processor for performing computing operations, the processor housed in the package; (c) at least one memory component for storing program code of an operating system, at least one memory component housed in the package; (d) a computing-engine connector, housed in the package, for providing electrical power and operational connectivity to the processor by connecting the computing-engine connector to a first peripheral assembly, wherein the computing-engine connector is a contact pad; (e) program code, residing on at least one memory component, for enabling functional operation of the computing engine as a main processing unit of a computing portal, wherein the computing portal includes the computing engine and the peripheral assembly, upon operational connection of the computing engine to the first peripheral assembly; and (f) a peripheral-assembly interface residing on the first peripheral assembly, wherein the computing engine is configured to be engaged within the first peripheral assembly via the computing-engine connector, and is configured to be logically switched from operating with the first peripheral assembly to operating with a second peripheral assembly, via connection of the peripheral-assembly interface to the second peripheral assembly, without the computing engine being disengaged from the first peripheral assembly.

Preferably, the first peripheral assembly is a mobile phone.

Preferably, the peripheral-assembly interface includes a wireless communication link.

Preferably, the peripheral-assembly interface includes a wired communication link.

Preferably, the package occupies a volume of less than about 5 cubic centimeters.

According to the present invention, there is provided for the first time a docking station including: (a) a computing-engine interface for connecting the computing engine, provided above, to the docking station; and (b) a plurality of interfaces for operationally connecting the docking station to peripheral devices.

Preferably, the peripheral devices include a power source.

Preferably, the peripheral devices include a mediator computer.

Most preferably, the mediator computer is configured to operationally connect the docking station to mediator peripheral devices, wherein the mediator peripheral devices are operationally connected to the mediator computer.

Preferably, the plurality of interfaces is configured to operationally connect the docking station to peripheral devices via a wireless communication link.

According to the present invention, there is provided for the first time a method of doing business including the steps of: (a) configuring a peripheral component with an operational interface for the computing engine, provided above; and (b) offering the peripheral component for sale.

Preferably, the method further includes the steps of: (c) operationally connecting the computing engine, provided above, to the peripheral component via the operational interface; and (d) running a benchmarking test from the computing engine on the peripheral component.

Most preferably, the configuring and the offering for sale are performed by a vendor of the peripheral component, and wherein the operational connecting of the computing engine, provided above, to the peripheral component and the running of the benchmark test are performed by a potential customer of the vendor.

Most preferably, the step of running a benchmarking test includes running a software application.

Most preferably, the step of running a benchmarking test includes opening a file.

Most preferably, the step of running a benchmarking test includes displaying an image.

Most preferably, the step of running a benchmarking test includes playing a audio file.

Most preferably, the step of running a benchmarking test includes observing a response to a trigger of the peripheral component.

According to the present invention, there is provided for the first time an article of furniture including: (a) a furniture body; (b) a peripheral assembly integrated into the furniture body, the peripheral assembly including: (i) an interface for the computing engine, provided above; and (ii) an operational component configured to be operated by the computing engine when the computing engine is reversibly operationally connected to the interface.

Preferably, the furniture body is a seat, and the peripheral assembly is integrated into a seatback of the seat.

Preferably, the furniture body is a panel, and the peripheral assembly is integrated into a peripheral-assembly support of the panel.

According to the present invention, there is provided for the first time a vehicle comprising a plurality of the articles of furniture, provided above.

According to the present invention, there is provided for the first time a peripheral assembly including: (a) an interface for the computing engine, provided above; and (b) a peripheral component configured to be operated by the computing engine when the computing engine is reversibly operationally connected to the interface.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified schematic block diagram of the architecture of a typical prior-art computing device;

FIG. 2A is a simplified schematic block diagram of the components of a computing engine and a peripheral assembly, according to a preferred embodiment of the present invention;

FIG. 2B is a simplified schematic block diagram of the components of FIG. 2A with a ROM-only computing engine, according to another preferred embodiment of the present invention;

FIG. 3A is a simplified schematic block diagram of one type of computing portal system architecture, according to a preferred embodiment of the present invention;

FIG. 3B is a simplified schematic block diagram of a variant of the computing portal system architecture of FIG. 3A, according to a preferred embodiment of the present invention;

FIG. 3C shows the computing engine of FIG. 3B operationally connected to both peripheral assemblies forming a computing portal system;

FIG. 4A is a simplified schematic block diagram of the hardware architecture of a computing engine, according to a preferred embodiment of the present invention;

FIG. 4B is a simplified physical external diagram of the computing engine of FIG. 4A having a contact pad within the periphery of the computing engine, according to a preferred embodiment of the present invention;

FIG. 4C is a simplified physical external diagram of the computing engine of FIG. 4A having a contact pad at the periphery of the computing engine, according to a preferred embodiment of the present invention;

FIG. 5 is a simplified schematic block diagram of the high-level software architecture of a computing engine, according to a preferred embodiment of the present invention,

FIG. 6A shows a seating system having an integrated peripheral assembly in the seatback, according to a preferred embodiment of the present invention;

FIG. 6B shows a detailed view of the display device for the integrated peripheral assembly of FIG. 6A, according to a preferred embodiment of the present invention;

FIG. 6C shows a detailed view of the input device for the integrated peripheral assembly of FIG. 6A, according to a preferred embodiment of the present invention;

FIG. 7A shows an integrated peripheral assembly as a tabletop console, according to a preferred embodiment of the present invention;

FIG. 7B shows a detailed view of the display device for the integrated peripheral assembly of FIG. 7A, according to a preferred embodiment of the present invention;

FIG. 7C shows a detailed view of the input device for the integrated peripheral assembly of FIG. 7A, according to a preferred embodiment of the present invention;

FIG. 8 is a photograph of a vehicle showing iconic representations of the integrated peripheral assemblies of FIGS. 6A and 7A, according to preferred embodiments of the present invention.

### DESCRIPTION OF THE PREFERRED EMBODIMENTS

The present invention relates to systems and methods for a modular computing environment comprising computing engines and peripheral assemblies. The principles and operation for a modular computing environment comprising computing engines and peripheral assemblies, according to the present invention, may be better understood with reference to the accompanying description and the drawings.

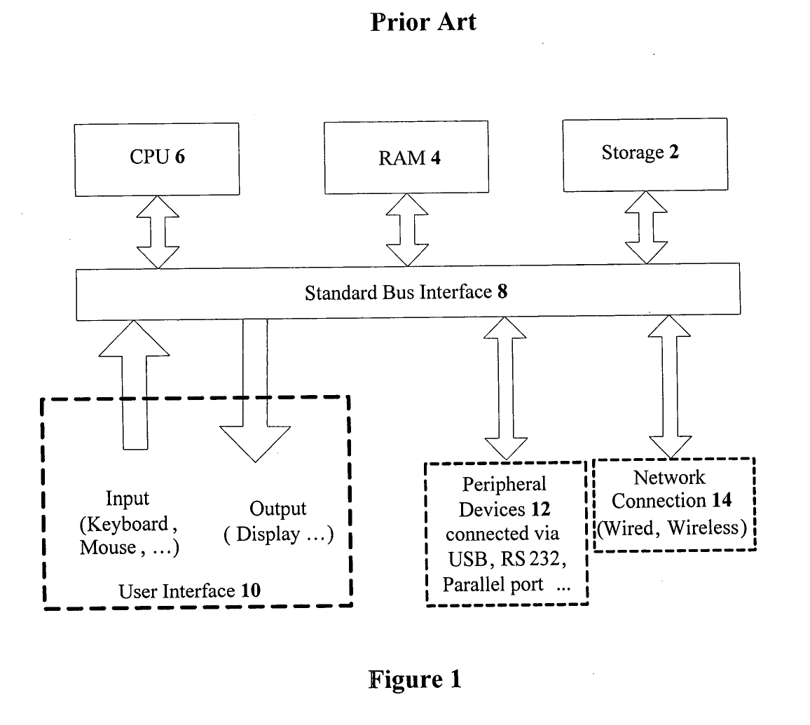

Referring now to the drawings, FIG. 1 is a simplified schematic block diagram of the architecture of a typical prior-art computing device. On a non-volatile storage device 2, such as a hard disk, reside all programs and program data (e.g. applications, databases, files, drivers, etc.). A RAM 4 and a CPU 6 perform the computing tasks. The contents of RAM 4 are erased when RAM 4 is disconnected from a power source (not shown). A standard bus interface 8 connects storage device 2, RAM 4, and CPU 6 to a user interface 10 which includes input and output devices (e.g. keyboard, mouse, display). Standard bus interface 8 typically includes ports such as USB ports, serial ports, and parallel ports, and also provides means for interfacing with various types of peripheral devices 12. A network connection 14 provides the means for communication with other computing devices and servers, and can be wired or wireless.

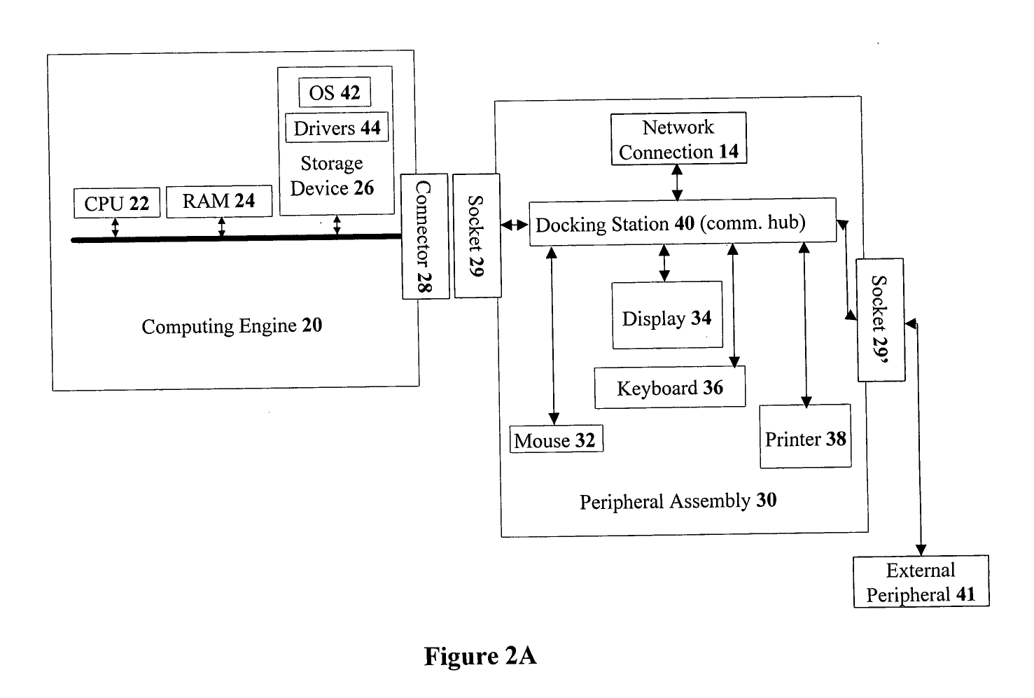

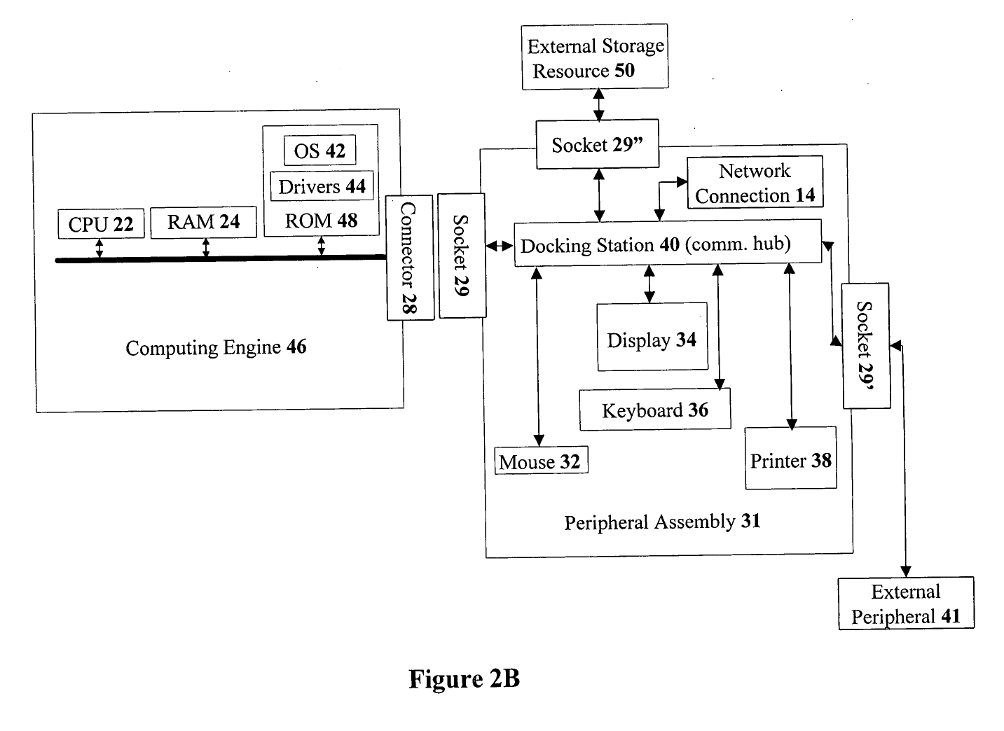

FIG. 2A is a simplified schematic block diagram of the components of a computing engine and a peripheral assembly, according to a preferred embodiment of the present invention. The main components of a computing engine 20 are a CPU 22, a RAM 24, and a non-volatile storage device 26. A connector 28 is used for connecting computing engine 20 to a socket 29 housed in a peripheral assembly 30. In preferred embodiments, connector 28 is a flat contact pad, such as the smartcard 8-pin connector defined by the ISO 7816 standard, for example, and socket 29 is a computing-engine slot for engaging connector 28. Peripheral assembly 30 includes a network connection 14, a mouse 32, a display 34, a keyboard 36, and a printer 38. A docking station 40 is used as a communication hub for operationally connecting all components of peripheral assembly 30 via socket 29 to computing engine 20.

Docking station 40 can be a USB hub, Ethernet switch, dedicated peripheral-assembly controller, or a smartcard reader for example. In the case that docking station 40 is a smartcard reader, docking station 40 does not connect to an external computer, as traditional smartcard readers do, unless the external computer is serving as a mediator device to provide resources (i.e. power and peripherals) to computing engine 20. Furthermore, when docking station 40 is a smartcard reader, socket 29 is a computing-engine slot interfacing the contact pad of connector 28. In addition, wireless connectivity to the resources via the mediator computer is provided in preferred embodiments in which network connection 14 resides in docking station 40.

Peripheral assembly 30 also includes a socket 29′ for connecting an external peripheral 41. The combination of computing engine 20 and peripheral assembly 30 form a computing portal for a user to access and perform operations with all data stored on the computing engine 20, as well as produce and store new data, or exchange data via network connection 14.

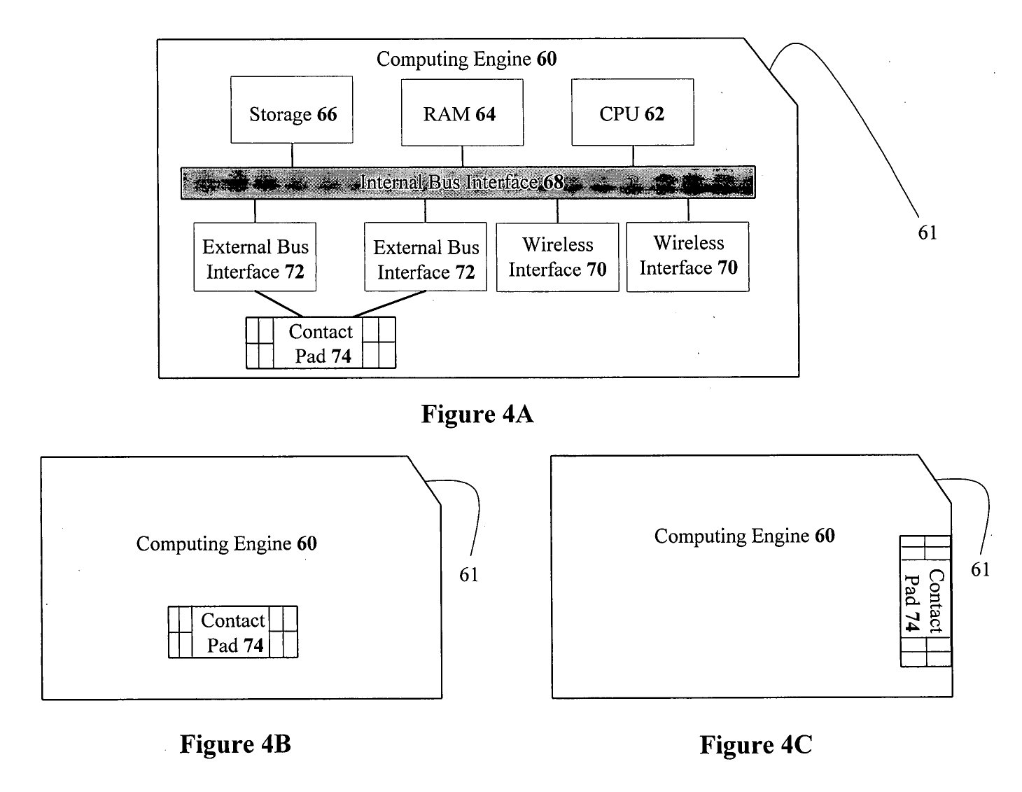

Computing engine 20 is a portable component, which is embedded within a small solid package (shown in FIG. 4A), and functions as the main processing unit of a data-processing system. Computing engine 20 includes no space-consuming peripherals. Therefore, computing engine 20 can be packaged, for example, in a form factor of an ordinary credit card that fits into a wallet, or in a smartcard form factor (ISO 7816 specifications standards—full-size credit card, ID1, and small-size SIM card, ID-000), a multi-media card (i.e. MMC specification standard), or Secure Digital™ (SD™) card. CPU 22 can be, for example, a processor from the ARM9 processor family from ARM Inc., 141 Caspian Court, Sunnyvale, Calif. 94089-1013.

Storage device 26 can be, for example, a NAND-type or NOR-type flash memory from Toshiba America, Inc. 1251, Avenue of the Americas, Suite 4110, New York, N.Y. 10020. The interface between computing engine 20 and peripheral assembly 30 can be, for example, a USB, MMC, or Ethernet interface. Computing engine 20 includes an operating system, OS 42, and a large variety of device drivers 44, residing in storage device 26, to enable compatibility with many types of peripheral assemblies. In addition, storage device 26 includes all applications necessary to perform the user's tasks (e.g. office applications and web-browsing applications). Optionally, computing engine 20 also includes a secured access control for preventing unauthorized access.

The present invention enables a user to carry a computing device in his/her wallet or pocket. Computing engine 20 leaves no trace of operational usage on peripheral assemblies the user has connected to. The present invention enables the use of peripheral assemblies having small- or large-size peripherals (e.g. mouse 32, display 34, and keyboard 36), according to the circumstances and the desire of the user. The present invention enables the user to upgrade the computing environment by replacing computing engine 20 at a minimal cost (relative to purchasing new conventional components), and without considerable setup time. During upgrading, there is no need to dispose of good components (e.g. components of peripheral assembly 30).

In addition, computing engine 20 can be configured to operationally connect as an external device to a host system such as a conventional computer. In such an arrangement, a user could configure the host system to bypass the CPU, RAM, and storage device of the host system (e.g. detect and run external devices before booting host OS). This would allow computing engine 20 the enhanced versatility of running on a wider array of peripheral assemblies. Such a situation could arise where security concerns require computing engine 20 to be accessed without the risk of contamination or theft by the host system. In an alternate configuration, computing engine 20 could be utilized by the host system as a co-processor for enhancing the performance of the host CPU. In computationally-intensive applications, computing engine 20 could improve the overall performance of the host system.

FIG. 2B is a simplified schematic block diagram of the components of FIG. 2A with a ROM-only computing engine, according to another preferred embodiment of the present invention. A computing engine 46 is shown in a similar configuration with a peripheral assembly 31. In contrast to computing engine 20 of FIG. 2A, computing engine 46 does not have a rewritable storage device similar to storage device 26 of FIG. 2A. In computing engine 46, OS 42 and device drivers 44 reside in a ROM 48. It is noted that, while not explicitly shown in FIG. 2A, computing engine 20 also contains a ROM component which is considered to be an integral part of CPU 22. For example, the ROM component of computing engine 20 is used to store boot code for computing engine 20. In FIG. 2B, ROM 48 is shown separately to illustrate the location of OS 42 and device drivers 44.

In contrast to peripheral assembly 30 of FIG. 2A, FIG. 2B also shows an external storage resource 50, connecting to peripheral assembly 31 via an additional socket 29″, for storing files, drivers, and applications not stored in ROM 48. Such files, drivers, and applications can be accessed on computing engine 46 by loading them into RAM 24. External storage resource 50 can be, for example, a portable flash memory device such as a Disk-On-Key™ memory device available from msystems Ltd., Kefar Saba, Israel. Computing engine 46 of FIG. 2B, in contrast to computing engine 20 of FIG. 2A, has the advantage of eliminating any possibility of unauthorized access (e.g. viruses and malware) to computing engine 46, since there is no rewritable storage device in computing engine 46.

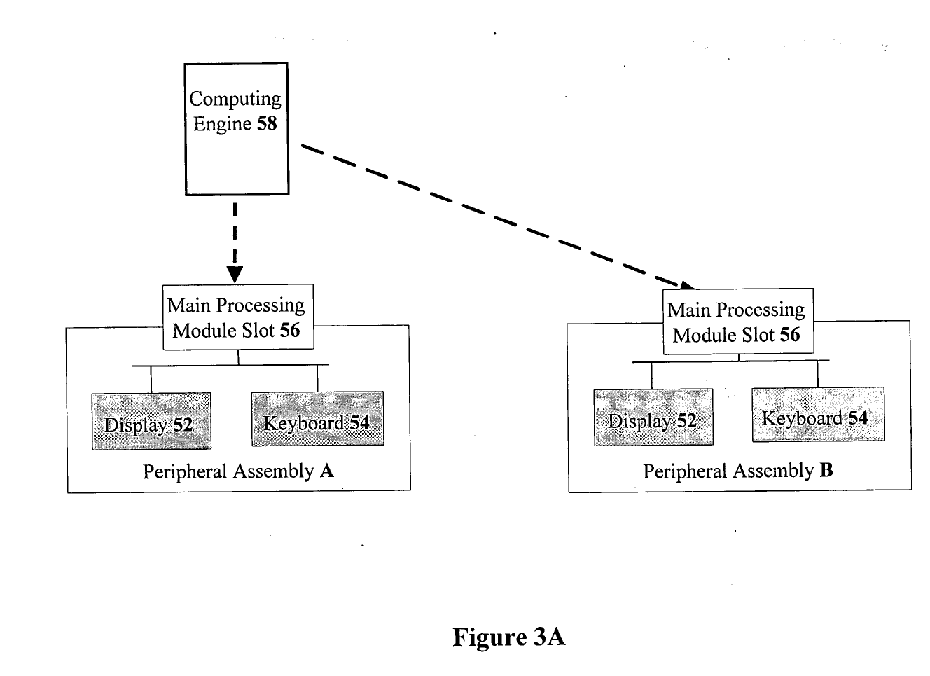

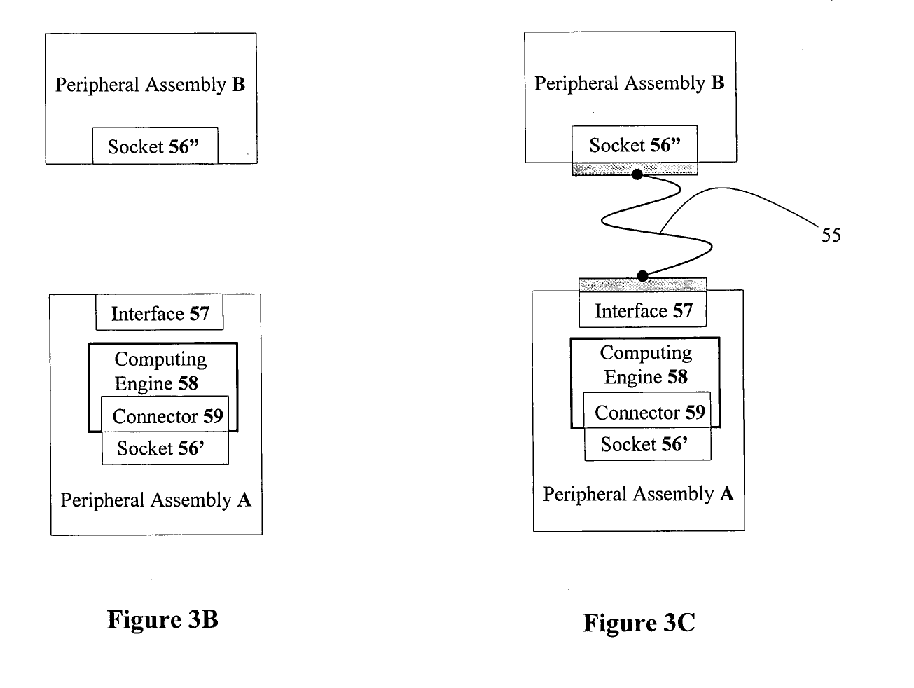

FIG. 3A is a simplified schematic block diagram of one type of computing portal system architecture, according to a preferred embodiment of the present invention. In this example, two peripheral assemblies, a peripheral assembly A and a peripheral assembly B, alternatively fulfill the peripheral-assembly functionality. Each peripheral assembly has a display 52, a keyboard 54, and a processing module slot 56 for connecting to a computing engine 58. Computing engine 58 serves as the computing system, while peripheral assemblies A and B provide input/output peripherals. All software needed for the system to function is stored in computing engine 58, including the operating system and applications. Computing engine 58 may include a read/write non-volatile memory, like storage device 26 of computing engine 20 of FIG. 2A, or may have only a ROM component, like ROM 48 of computing engine 46 of FIG. 2B.

Upon attaching computing engine 58, which is a small solid package, to peripheral assembly A or B, the combination of computing engine 58 with peripheral assembly A or B becomes a fully-functional computing system, providing all intended computing services (e.g. typical personal computer functionality). Upon detaching computing engine 58 from peripheral assembly A or B, no trace of computing engine 58 remains on the peripheral assembly because none of the components of the peripheral assemblies have externally-writable memories; the components either have internal ROM or volatile memory, for example. Upon attaching computing engine 58 into peripheral assembly B, computing work previously performed utilizing peripheral assembly A can be accessed and continued, allowing “seamless” workflow. If computing engine 58 has only a ROM 48 for a memory, as in computing engine 46 of FIG. 2B, then to save work done using peripheral assembly A, peripheral assembly A needs to be configured like peripheral assembly 31 of FIG. 2B to accommodate external storage resource 50.

FIG. 3B is a simplified schematic block diagram of a variation of the computing portal system architecture of FIG. 3A, according to a preferred embodiment of the present invention. In this embodiment, computing engine 58 can be logically switched from peripheral assembly A to peripheral assembly B. One example of such an application is where peripheral assembly A is a mobile phone having computing engine 58 plugged into the mobile phone. In this configuration, peripheral assembly A is only a functional mobile phone when a connector 59 of computing engine 58 is engaged in a socket 56′ of peripheral assembly A.

FIG. 3C shows the computing engine of FIG. 3B operationally connected to both peripheral assemblies forming a computing portal system. In such a case, computing engine 58 is configured to logically switch to peripheral assembly B upon connection of a connector cable 55 between an interface 57 of peripheral assembly A and socket 56″ of peripheral assembly B, forcing peripheral assembly A to become dormant. Upon terminating connection of connector cable 55 between peripheral assembly A and peripheral assembly B, peripheral assembly A becomes active again. In such a configuration, computing engine 58 would “recognize” peripheral assembly A as a mobile phone, allowing functionality appropriate to such a device. Similarly, computing engine 58 would “recognize” peripheral assembly B according to the way computing engine 58 was configured to handle secondary peripheral assemblies. Such a configuration may be defined by the manufacturer or the user depending on the desired limitations of the device.

The logical switching, of the computing portal system described above, functions as follows. When only socket 56′ is engaged, computing engine 58 runs the peripheral assembly A. When socket 56′ and interface 57 are engaged in peripheral assemblies A and B, respectively, computing engine 58 runs peripheral assembly B, and ignores peripheral assembly A.

FIG. 4A is a simplified schematic block diagram of one type of hardware architecture of a computing engine, according to a preferred embodiment of the present invention. A computing engine 60, housed in a solid package 61, includes a CPU 62 serving as the processing core. A RAM 64 and a non-volatile storage device 66 are connected via an internal bus interface 68 to CPU 62. Internal bus interface 68 is used for data transfer between all the internal data-processing modules (i.e. CPU 62, RAM 64, and storage device 66). Storage device 66 is a non-volatile data storage device such as a flash memory device or a ROM. Computing engine 60 optionally includes one or more wireless external interfaces 70 and/or wired external BUS interfaces 72. External BUS interfaces 72 can operationally connect to devices outside of computing engine 70 via a contact pad 74. Contact pad 74 can be a flat connector such as the smartcard 8-pin connector defined by the ISO 7816 standard.

FIG. 4B is a simplified physical external diagram of the computing engine of FIG. 4A having a contact pad within the periphery of the computing engine, according to a preferred embodiment of the present invention. While contact pad 74 is shown within the periphery of package 61 in FIG. 4A, contact pad 74 can also be located at the periphery of package 61 as an edge connector. FIG. 4C is a simplified physical external diagram of the computing engine of FIG. 4A having a contact pad within the periphery of the computing engine, according to a preferred embodiment of the present invention. The form factor of package 61, shown in FIGS. 4A-4C, is a feature of a preferred embodiment of the present invention. Namely, the form factor of package 61 housing computing engine 60 can be similar to the form factor of a smartcard, such as ISO 7816 specifications standards—full-size credit card, ID1, and small-size SIM card, ID-000, a multi-media card (i.e. MMC specification standard), or Secure Digital™ (SD™) card, as mentioned above.

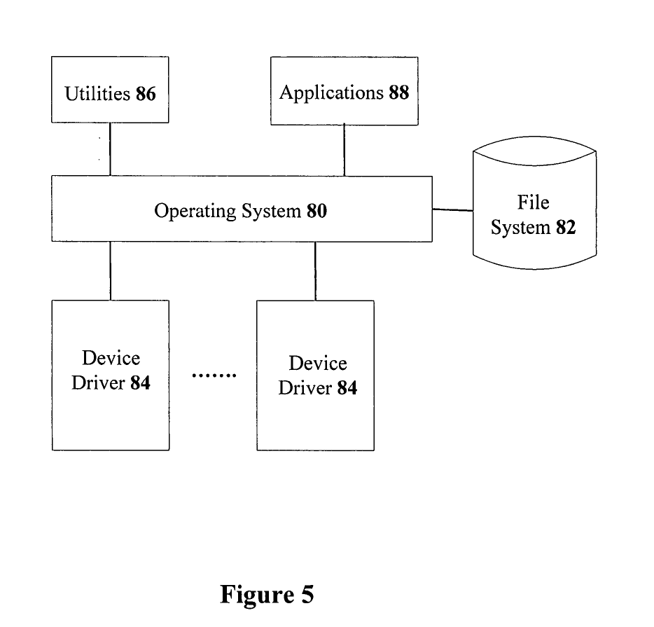

FIG. 5 is a simplified schematic block diagram of one type of high-level software architecture installed on a computing engine, according to a preferred embodiment of the present invention. An operating system 80 manages the data-processing activities. Operating system 80 is connected to a file system 82 used for storing user data and applications. Operating system 80 has a variety of device drivers 84 supporting a wide variety of peripheral-assembly devices as described above, and utilities 86 and application 88 for providing the functionality of the system as desired by the user. Operating system 80 enables functional operation of the computing engine as a main processing unit of the peripheral assembly upon operational connection. This is a distinguishing feature of the present invention in contrast to the prior art.

The present invention enables the same user to interface with a mobile phone, a landline phone, a PDA, a PC, or other host device. The operating system uses the requisite device drivers for the peripherals connected to these host devices. Since the computing engine keeps all of the user's data on-board, there is no need to synchronize the data with any of the databases on the external host devices (e.g. phone book or scheduler). Another unique feature of the present invention is that the computing engine enables a user to test a new computing environment in a computer store by plugging his/her computing engine into a local demonstration peripheral assembly. Peripheral assemblies can be large and include a full-size keyboard, a large display, a printer, a scanner, and a fax machine, for example. Peripheral assemblies can also be compact such as hand-held input devices, PDAs, compatible mobile phones, and compact work areas in a airplane or train seatback, for example.

The computing engine can provide different functionality depending on the type of hosting peripheral assembly. If the peripheral assembly is a mobile phone with a limited keypad, the functionality is limited to phonebook, calendar, appointment applications, and similar applications available on cell phones. However, if the computing engine is connected to a PDA, for example, the functionality of the computing engine is enhanced, and includes e-mail services, word processing, and other applications. Depending on the peripherals provided by the peripheral assembly, additional functionality could be provided, such as a touch-responsive display for example.

Another application of such a computing engine is as a “try before you buy” testing device for peripheral components a user is considering purchasing. In such an application, the user can connect his/her computing engine to display-model peripherals in a store, enabling the user to benchmark performance and features of various peripherals on a standardized platform that the user is familiar with, namely, his/her own computing engine.

A prior art device similar to the present invention is described in U.S. Pat. No. 7,035,949 to Bychkov et al. (assigned to the assignee of the present invention and henceforth referred to as Bychkov '949) teaches a data storage and processing device for connecting to various digital appliances (e.g. MP3 player, digital camera, etc.).

In the present invention, a computing engine functions exclusively as a “master” device, meaning that a computing engine can only serve to perform operations on a peripheral assembly. In contrast, the data storage and processing device taught in Bychkov '949 can serve as a “slave” device, meaning the device can be controlled by a host system to provide access to data stored on the device. A computing engine, according to the present invention, cannot be controlled by any external device. The peripheral devices of a peripheral assembly are interfaces to a computing engine. Even the peripheral devices are controlled by device drivers running on the computing engine as shown in FIG. 5.

Thus, the present invention is not anticipated by the teachings of Bychkov '949. Furthermore, the present invention would not be considered obvious in light of Bychkov '949 to one ordinarily skilled in the art because Bychkov '949 teaches a device that can function as a slave device, having an entirely different capability and purpose of use to a master device.

To elaborate on the last point more explicitly, the essential difference between Bychkov '949 and the present invention is the difference between the respective “goals” and “means”. In Bychkov '949, the “goal” is the appliance (i.e. peripheral device), and the “means” is the portable device. The portable device helps to operate the appliance (e.g. camera and recorder). The portable device saves internal computing power in the appliances. An appliance having an internal processor will serve a user exactly in the same way as an appliance with a plug-in portable processor (i.e. the portable device of Bychkov '949). An appliance with an internal storage unit will serve the user exactly as an appliance with a plug-in portable storage unit (i.e. the portable device of Bychkov '949). The plug-in portable device is the “means” and the appliance is the “goal”.

Two different appliances are not alternatives to each other. Meaning, when the user needs to take photographs, an audio recorder will not help him/her. Similarly, when the user wants to play music, a GPS locator will not help him/her. The user is loyal to the peripheral, not to the processor (i.e. the portable device). The “identity” of the system is the “identity” of the appliance, not the portable device. The portable device fuels the operation of the appliance with processing power and storage power, similar to the role of a battery. The user can change the portable device, and continue his/her task.

In the present invention, the “goal” is the portable device (i.e. the computing engine), and the “means” is the appliance (i.e. the peripheral assembly). The various peripheral assemblies are “means” for operating the computing engines. The peripheral assembly serves the purpose of providing a user with an interface to the physical world (i.e. keyboard/mouse for the fingers, display for the eyes, and printer for the hardcopy)—any keyboard, mouse, display, and printer will do. The user is “loyal” to the computing engine, not to the peripheral assembly. The “identity” of the system is the “identity” of the computing engine, not the peripheral assembly. The user can change the peripheral assembly to another peripheral assembly, and continue his/her task. However, the user cannot change his/her computing engine to another computing engine, and continue his/her task.

Another prior art device that provides similar functionality to the present invention is the uBOX Media Center Barebone System series of miniPCs available from PC Winner International, Inc., Taoyuan City, Taoyuan County 330, Taiwan, R.O.C. However, the uBOX series does not provide nor teach the form factor advantage of package 61 of FIG. 4 of the present invention. Furthermore, the uBOX series does not provide nor teach the solid package criteria of package 61 of FIG. 4 of the present invention. Moreover, the uBOX series neither provides nor teaches the ease of connectivity provided by contact pad 74 of FIG. 4 of the present invention.

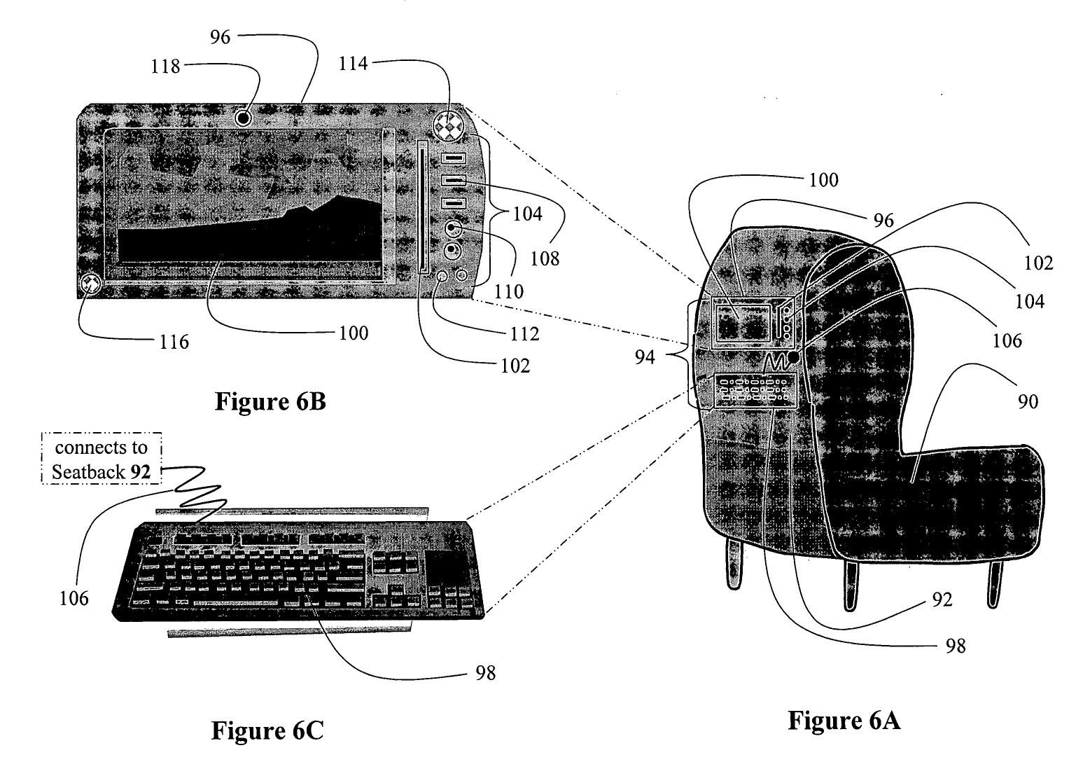

While the computing engine is an essential element of the present invention, the peripheral assembly is necessary for the computing engine to be functional. Providing conveniently-accessible peripheral assemblies enables the use of such computing engines to become ubiquitous. Such peripheral assemblies can be integrated into furniture, providing the added utility of a fully-equipped computing environment for computing engine users. FIG. 6A shows a seating system having an integrated peripheral assembly in the seatback, according to a preferred embodiment of the present invention. A seat 90 having a seatback 92 is shown. Seat 90 can be a vehicle seat (e.g. a car seat, a train seat, and an airplane seat). In addition, seat 90 can be a stationary seat located in convenient locations (e.g. university lecture halls, hotel lobbies, and airport terminals). An integrated peripheral assembly 94, having a display device 96 and an input device 98, resides in seatback 92, available to a user seated behind seat 90. Seat 90 provides electrical power, and optionally, network communications, via internal wirings (not shown). Display device 96 has a display screen 100, a computing-engine slot 102, and a control panel 104. Optionally, display screen 100 can be a touch-sensitive screen. Input device 98 is shown with a security cable 106 that connects to seatback 92. Similarly, display device 96 has a security housing (not shown) in seatback 92, preventing theft.

FIG. 6B shows a detailed view of the display device for the integrated peripheral assembly of FIG. 6A, according to a preferred embodiment of the present invention. Control panel 104 of display device 96 has external device ports 108 (e.g. USB ports), adjustment controls 110 (e.g. volume and contrast), and input jacks 112 (e.g. headphone connectors). Optionally, display device 96 has a speaker 114, a microphone 116, a camera 118, and an internal communication device (not shown). It should be clear that what is missing from display device 96 is a computing engine. Computing-engine slot 102 accommodates the computing engine of the user. In this way, peripheral assembly 94 is inexpensive, and protected from system attack (e.g. viruses, malware, and computer hacking). Furthermore, peripheral assembly 94 has a greater utility life, since computing power and software all reside on the computing engine, thereby making the user responsible for remaining current with new hardware, applications, and software updates.

FIG. 6C shows a detailed view of the input device for the integrated peripheral assembly of FIG. 6A, according to a preferred embodiment of the present invention. Input device 98 is shown in FIG. 6C as a keyboard. Optionally, input device 98 can integrate other input devices such as a trackball, a “stick mouse”, a writing tablet, and a fingerprint reader (all not shown). Alternatively, input device 98 can be solely a writing tablet. Optionally, security cable 106 can carry the connection cord (not shown) for input device 98. Alternatively, input device 98 can be a wireless device.

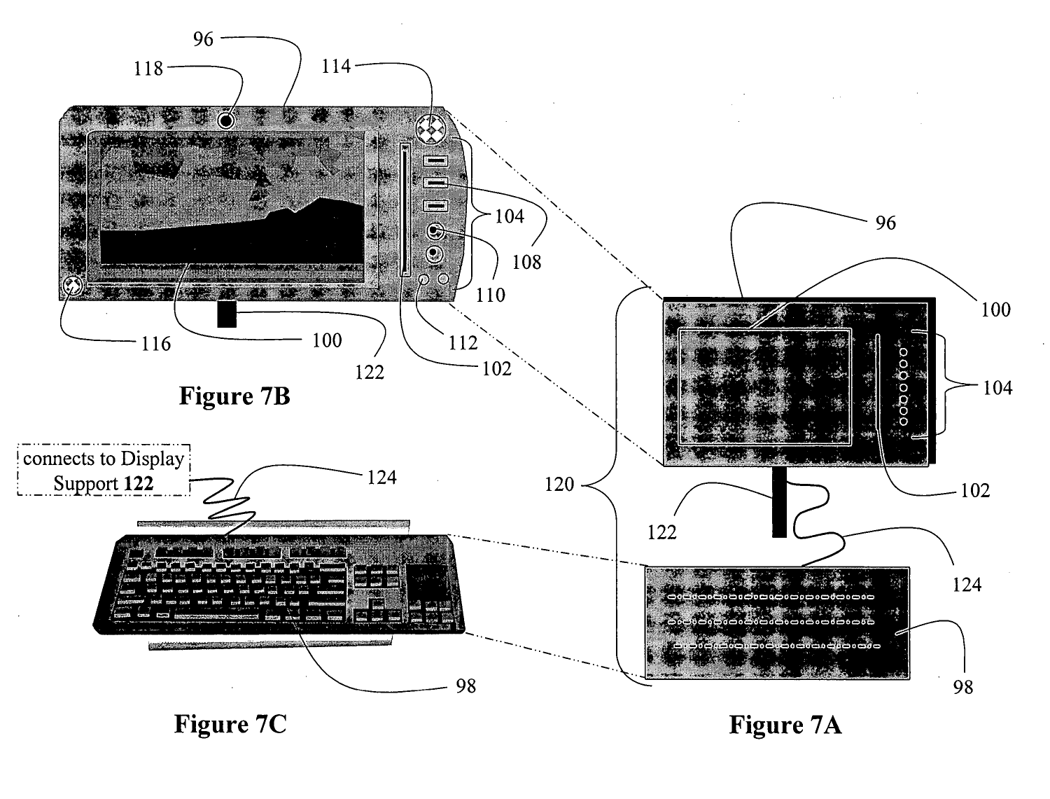

Another embodiment of the present invention that provides the added utility of a fully-equipped computing environment is a tabletop console. FIG. 7A shows an integrated peripheral assembly as a tabletop console, according to a preferred embodiment of the present invention. A peripheral assembly 120, having display device 96 and input device 98, is shown. Peripheral assembly 120 is a tabletop console that can be located in convenience locations (e.g. a restaurant, a study hall, and an Internet cafe). A display support 122, connected to a tabletop console (not shown), supports, and prevents theft of, display device 96. Display support 122 also swivels to make viewing of display device 96 convenient for a user. A security cable 124, attached to input device 98, is secured to display support 122, and prevents theft of input device 98.

FIG. 7B shows a detailed view of the display device for the integrated peripheral assembly of FIG. 7A, according to a preferred embodiment of the present invention. FIG. 7C shows a detailed view of the input device for the integrated peripheral assembly of FIG. 7A, according to a preferred embodiment of the present invention. Components that are common to FIGS. 6B, 6C, 7B, and 7C share common reference numerals.

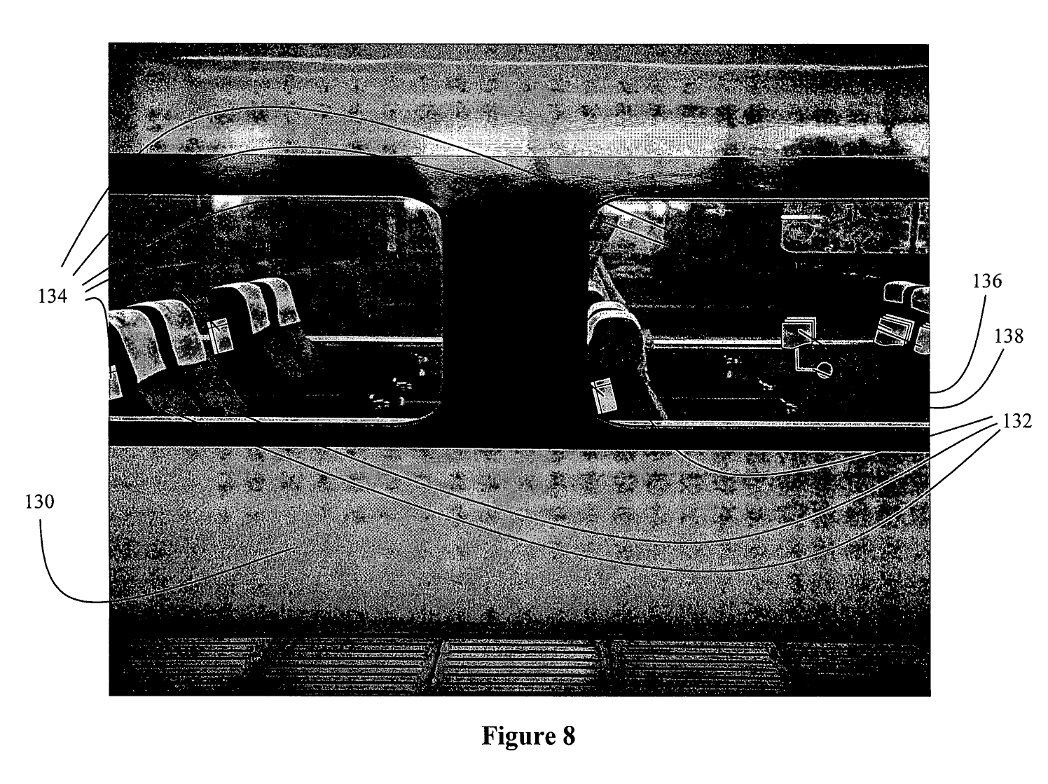

FIG. 8 is a photograph of a vehicle retouched to show iconic representations of the integrated peripheral assemblies of FIGS. 6A and 7A, according to preferred embodiments of the present invention. A vehicle 130 is shown having seats 132. Vehicle 130 is shown as a railroad car, but alternatively can be, for example, an airplane or an automobile. In a preferred embodiment of the present invention, seats 132 are similar to seat 90 of FIG. 6A having seatback 92 housing integrated peripheral assembly 94. Cushion consoles 134 are depicted in FIG. 8. In an alternate preferred embodiment of the present invention, vehicle 130 is equipped with tabletop consoles 136. Tabletop consoles 136 are similar to peripheral assembly 120, mounted on display support 122, of FIG. 7A. Tabletop consoles 136, depicted in FIG. 8, are mounted on swivel supports 138, allowing users to maneuver tabletop consoles 136 for convenient use.

While the invention has been described with respect to a limited number of embodiments, it will be appreciated that many variations, modifications, and other applications of the invention may be made.

What is claimed is:

1. A computing portal system comprising:
(a) a computing engine for performing computing operations;
(b) at least one memory component for storing program code of an operating system;
(c) a computing-engine connector for providing operational connectivity to said computing engine, wherein said computing-engine connector is a contact pad;
(d) a solid package for housing said computing engine, said at least one memory component, and said computing-engine connector;
(e) at least two peripheral assemblies, each said peripheral assembly for providing electrical power and peripheral resources when operationally connected to said computing-engine connector; and
(f) program code, residing on said at least one memory component, for enabling functional operation of said computing engine as a main processing unit of each computing portal, wherein each computing portal includes said computing engine and one of said at least two peripheral assemblies, upon operational connection of said computing engine to said one peripheral assembly.

2. The system of claim 1, wherein one of said peripheral assemblies is a mobile phone.

3. The system of claim 1, wherein each said peripheral assembly includes at least one connector for interfacing with said computing engine.

4. The system of claim 1, wherein said package has a Smartcard ID1 form factor.

5. The system of claim 1, wherein said package has a Smartcard ID-000 form factor.

6. The system of claim 1, wherein said computing-engine connector is a sole computing-engine connector.

7. The system of claim 1, wherein at least one said peripheral assembly is a fully-functional computing system.

8. The system of claim 7, wherein said fully-functional computing system is configured to assist in performing computing operations in conjunction with said computing engine.

9. The system of claim 1, wherein said computing engine includes a secured access control for preventing unauthorized access.

10. The system of claim 1, wherein said memory component is a non-volatile data-storage device.

11. The system of claim 10, wherein said at least one memory component is a ROM component.

12. The system of claim 1, wherein said contact pad is an ISO 7816 standard connector.

13. The system of claim 1, wherein said package is dimensioned to be smaller than about 5 cubic centimeters.

14. A computing portal system for logically switched operation between devices, the system comprising:
(a) a computing engine for performing computing operations;
(b) at least one memory component for storing program code of an operating system;
(c) a computing-engine connector for providing operational connectivity to said computing engine, wherein said computing-engine connector is a contact pad;
(d) a solid package for housing said computing engine, said at least one memory component, and said computing-engine connector;
(e) at least two peripheral assemblies, each said peripheral assembly for providing electrical power and peripheral resources when operationally connected to said computing-engine connector;
(f) program code, residing on said at least one memory component, for enabling functional operation of said computing engine as a main processing unit of each computing portal, wherein said each computing portal includes said computing engine and one of said at least two peripheral assemblies, upon operational connection of said computing engine to said one peripheral assembly; and
(g) a peripheral-assembly interface residing on a first said peripheral assembly, wherein said computing engine is configured to be engaged within said first peripheral assembly via said computing-engine connector, and is configured to be logically switched from operating with said first peripheral assembly to operating with a second said peripheral assembly, via connection of said peripheral-assembly interface to said second peripheral assembly, without said computing engine being disengaged from said first peripheral assembly.

15. The system of claim 14, wherein said first peripheral assembly is a mobile phone.

16. The system of claim 14, wherein said peripheral-assembly interface includes a wireless communication link.

17. The system of claim 14, wherein said peripheral-assembly interface includes a wired communication link.

18. A computing engine consisting essentially of:
(a) a solid package;
(b) a processor for performing computing operations, said processor housed in said package;
(c) at least one memory component for storing program code of an operating system, said at least one memory component housed in said package;
(d) a computing-engine connector, housed in said package, for providing electrical power and operational connectivity to said processor by connecting said connector to a peripheral assembly, wherein said computing-engine connector is a contact pad; and
(e) program code, residing on said at least one memory component, for enabling functional operation of the computing engine as a main processing unit of a computing portal, wherein said computing portal includes the computing engine and said peripheral assembly, upon operational connection of the computing engine to said peripheral assembly.

19. The computing engine of claim 18, wherein said package has a Smartcard ID1 form factor.

20. The computing engine of claim 18, wherein said package has a Smartcard ID-000 form factor.

21. The computing engine of claim 18, wherein said peripheral assembly includes a mobile phone.

22. The computing engine of claim 18, wherein said contact pad is an ISO 7816 standard connector.

23. The computing engine of claim 18, wherein said memory component is a non-volatile data-storage device.

24. The computing engine of claim 23, wherein said memory component is a ROM component.

25. The computing engine of claim 18, wherein said package occupies a volume of less than about 5 cubic centimeters.

26. A computing engine for logically switched operation between devices, the computing engine consisting essentially of:
(a) a solid package;
(b) a processor for performing computing operations, said processor housed in said package;
(c) at least one memory component for storing program code of an operating system, said at least one memory component housed in said package;
(d) a computing-engine connector, housed in said package, for providing electrical power and operational connectivity to said processor by connecting said computing-engine connector to a first peripheral assembly, wherein said computing-engine connector is a contact pad;
(e) program code, residing on said at least one memory component, for enabling functional operation of the computing engine as a main processing unit of a computing portal, wherein said computing portal includes the computing engine and said peripheral assembly, upon operational connection of the computing engine to said first peripheral assembly; and
(f) a peripheral-assembly interface residing on said first peripheral assembly, wherein said computing engine is configured to be engaged within said first peripheral assembly via said computing-engine connector, and is configured to be logically switched from operating with said first peripheral assembly to operating with a second peripheral assembly, via connection of said peripheral-assembly interface to said second peripheral assembly, without said computing engine being disengaged from said first peripheral assembly.

27. The system of claim 26, wherein said first peripheral assembly is a mobile phone.

28. The system of claim 26, wherein said peripheral-assembly interface includes a wireless communication link.

29. The system of claim 26, wherein said peripheral-assembly interface includes a wired communication link.

30. The computing engine of claim 26, wherein said package occupies a volume of less than about 5 cubic centimeters.

31. A docking station comprising:
(a) a computing-engine interface for connecting the computing engine of claim 18 to the docking station; and
(b) a plurality of interfaces for operationally connecting the docking station to peripheral devices.

32. The docking station of claim 31, wherein said peripheral devices include a power source.

33. The docking station of claim 31, wherein said peripheral devices include a mediator computer.

34. The docking station of claim 33, wherein said mediator computer is configured to operationally connect the docking station to mediator peripheral devices, wherein said mediator peripheral devices are operationally connected to said mediator computer.

35. The docking station of claim 31, wherein said plurality of interfaces is configured to operationally connect the docking station to peripheral devices via a wireless communication link.

36. A method of doing business, the method comprising the steps of:
(a) configuring a peripheral component with an operational interface for the computing engine of claim 18; and
(b) offering said peripheral component for sale.

37. The method of claim 36, the method further comprising the steps of:
(c) operationally connecting the computing engine of claim 18 to said peripheral component via said operational interface; and
(d) running a benchmarking test from the computing engine of claim 18 on said peripheral component.

38. The method of claim 37, wherein said configuring and said offering for sale are performed by a vendor of said peripheral component, and wherein said operational connecting of the computing engine of claim 18 to said peripheral component and said running of said benchmark test are performed by a potential customer of said vendor.

39. The method of claim 37, wherein said step of running a benchmarking test includes running a software application.

40. The method of claim 37, wherein said step of running a benchmarking test includes opening a file.

41. The method of claim 37, wherein said step of running a benchmarking test includes displaying an image.

42. The method of claim 37, wherein said step of running a benchmarking test includes playing a audio file.

43. The method of claim 37, wherein said step of running a benchmarking test includes observing a response to a trigger of the peripheral component.

44. An article of furniture comprising:
(a) a furniture body;
(b) a peripheral assembly integrated into said furniture body, said peripheral assembly including:
(i) an interface for the computing engine of claim 18; and
(ii) an operational component configured to be operated by the computing engine of claim 18 when the computing engine of claim 18 is reversibly operationally connected to said interface.

45. The article of furniture of claim 44, wherein said furniture body is a seat, and said peripheral assembly is integrated into a seatback of said seat.

46. The article of furniture of claim 44, wherein said furniture body is a panel, and said peripheral assembly is integrated into a peripheral-assembly support of said panel.

47. A vehicle comprising a plurality of the articles of furniture of claim 44.

48. A peripheral assembly comprising:
(a) an interface for the computing engine of claim 18; and
(b) a peripheral component configured to be operated by the computing engine of claim 18 when the computing engine of claim 18 is reversibly operationally connected to said interface.
